(19) United States
(12) Patent Application Publication
(10) Pub. No.: US 2014/0046691 A1
(43) Pub. Date: Feb. 13, 2014

(54) METHOD, APPARATUS, AND COMPUTER PROGRAM PRODUCT FOR VERSIONING ELECTRONIC HEALTH RECORDS

(71) Applicants: Arien Malec, Oakland, CA (US); Brian Adams, San Leandro, CA (US)

(72) Inventors: Arien Malec, Oakland, CA (US); Brian Adams, San Leandro, CA (US)

(73) Assignee: MCKESSON FINANCIAL HOLDINGS, Hamilton (BM)

(21) Appl. No.: 13/571,059

(22) Filed: Aug. 9, 2012

(51) Int. Cl. G06Q 50/24

(52) U.S. Cl. 705/3

(57) ABSTRACT

A method, apparatus and computer program product are provided for electronic health record versioning. Data elements may be tagged with versioning information such as origin and timestamp. Versioning information and history may be available to users, and views showing values that have been changed since a last access time may be displayed. Users may override certain data elements with specific values.

### TECHNOLOGICAL FIELD

Embodiments of the present invention relate generally to computer technology and, more particularly, relate to methods, apparatuses, and computer program products for versioning electronic health records (EHR).

### BACKGROUND

The widespread use of modern computing technology has led to an increasing demand for information to be captured and made available via computer-based applications. The medical services industry in particular relies on systems to store and maintain patient data in a centralized location made accessible to various authorized users.

Various providers and individuals may have access to shared EHRs, maintained by a centralized system in order to provide the most up to date patient data available. EHRs may provide easy and efficient access to essential medical information for patients requiring emergency care and consolidated prescription details for medication prescribed by different practices. EHRs may also minimize the risk of losing patient records.

### BRIEF SUMMARY OF SOME EXAMPLE EMBODIMENTS

Methods, apparatuses, and computer program products are therefore provided for versioning electronic health records. Embodiments provided herein may provide several advantages for medical practitioners including access to reliable EHRs and history indicating provenance and timestamped changes to an EHR over time.

In some embodiments, a method is provided for receiving a new value of a data element associated with an EHR, receiving versioning information including a data source and/or a timestamp, and saving and tagging the new value with the versioning information in the EHR. According to some embodiments, the new value and versioning information may be received as a result of an automated data reconciliation process.

According to some embodiments, the method provides for receiving a request for data associated with an EHR, retrieving at least one value and associated versioning information, and causing transmission and/or display of data values and associated versioning information. In some embodiments, the method may additionally provide identifying a requestor of the request, identifying changed data since a last access time from the requestor, and causing display of the changed data to be distinguished from unchanged data. According to some embodiments, the method may include receiving indication of a preferred value from the requestor, and overriding associated values with the preferred value for use by the requestor.

In some embodiments, an apparatus is provided comprising processing circuitry to cause the apparatus to receive a new value of a data element associated with an EHR, to receive versioning information including a data source and/or a timestamp, and to save and tag the new value with the versioning information in the EHR. According to some embodiments, the new value and versioning information may be received as a result of an automated data reconciliation process.

According to some embodiments, the processing circuitry provides for receiving a request for data associated with an EHR, retrieving at least one value and associated versioning information, and causing transmission and/or display of data values and associated versioning information. In some embodiments, the processing circuitry may identify a requestor of the request, identify changed data since a last access time from the requestor, and cause display of the changed data to be distinguished from unchanged data. According to some embodiments, the processing circuitry may receive indication of a preferred value from the requestor, and override associated values with the preferred value for use by the requestor.

In some embodiments, a computer program product is provided comprising at least one non-transitory computer-readable medium having computer-readable program instructions stored therein with the computer-readable program instructions comprising instructions, which when performed by an apparatus, are configured to cause the apparatus to receive a new value of a data element associated with an EHR, receive versioning information including a data source and/or a timestamp, and save and tag the new value with the versioning information in the EHR. According to some embodiments, the new value and versioning information may be received as a result of an automated data reconciliation process.

According to some embodiments, the computer program product also includes instructions for causing the apparatus to receive a request for data associated with an EHR, to retrieve at least one value and associated versioning information, and to cause transmission and/or display of data values and associated versioning information. In some embodiments, the computer program product may include instructions for causing the apparatus to identify a requestor of the request, identify changed data since a last access time from the requestor, and cause display of the changed data to be distinguished from unchanged data. According to some embodiments, the computer program product may include instructions for causing the apparatus to receive indication of a preferred value from the requestor, and override associated values with the preferred value for use by the requestor.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the disclosure in any way. It will be appreciated that the scope of the disclosure encompasses many potential embodiments, some of which will be further described below, in addition to those here summarized.

### BRIEF DESCRIPTION OF THE SEVERAL VIEWS OF THE DRAWINGS

Having thus described embodiments of the invention in general terms, reference will now be made to the accompanying drawings, which are not necessarily drawn to scale, and wherein:

FIG. 1 illustrates a system for versioning EHRs according to some example embodiments;

FIG. 2 illustrates a block diagram of an EHR versioning apparatus in accordance with some example embodiments;

FIG. 3 illustrates a flowchart for tagging data with versioning information according to some example embodiments;

FIG. 4 illustrates a flowchart for retrieving tagged data according to some example embodiments;

FIG. 5 is a display illustrating versioning information according to some example embodiments;

FIG. 6 is a display illustrating changed information since a last access time according to some example embodiments; and

FIG. 7 is a display illustrating indicators used to override values according to some example embodiments.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

As used herein, where a computing device is described herein to receive data from another computing device, it will be appreciated that the data may be received directly from the another computing device and/or may be received indirectly via one or more intermediary computing devices, such as, for example, one or more servers, relays, routers, network access points, and/or the like. Similarly, where a computing device is described herein to send data to another computing device, it will be appreciated that the data may be sent directly to the another computing device or may be sent to the another computing device via one or more interlinking computing devices, such as, for example, one or more servers, relays, routers, network access points, and/or the like.

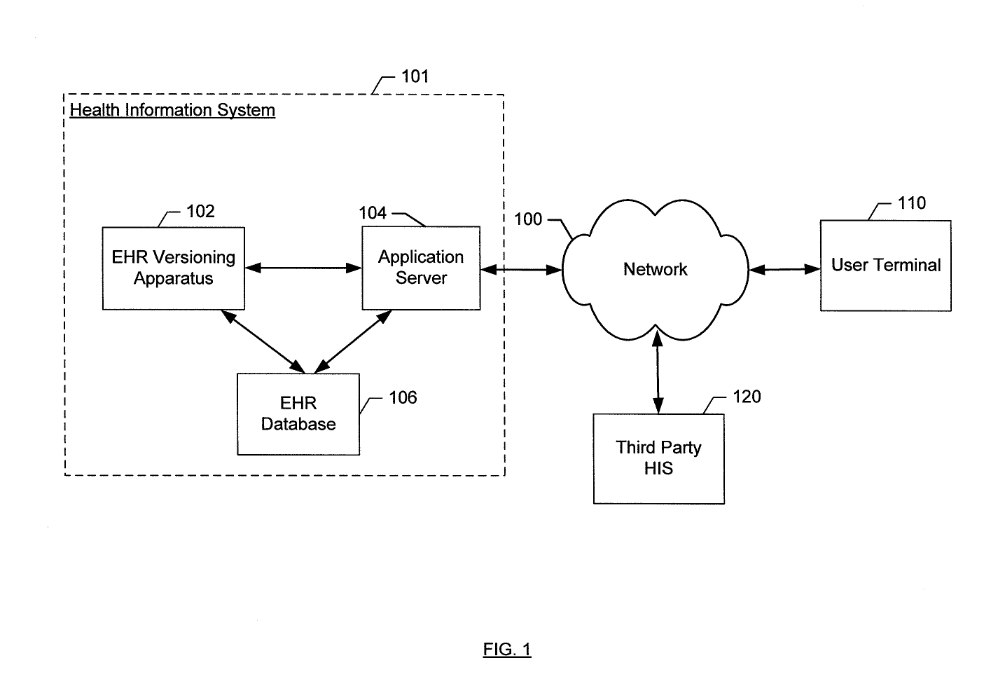

FIG. 1 illustrates a system 101 for versioning EHRs according to some example embodiments, as well as third party health information system (HIS) 120 and user terminal(s) 110 for communicating with system 101 over network 100. It will be appreciated that FIG. 1 as well as the illustrations in other figures are each provided as an example of an embodiment(s) and should not be construed to narrow the scope or spirit of the disclosure in any way. In this regard, the scope of the disclosure encompasses many potential embodiments in addition to those illustrated and described herein. As such, while FIG. 1 illustrates one example of a configuration of a system for versioning EHRs, numerous other configurations may also be used to implement embodiments of the present invention.

The system 101 may include any number of application server(s) 104 that may support and/or provide application code written in a variety of languages, providing functionality to access and/or maintain EHRs stored in any number of EHR database(s) 106. More specifically, application server(s) 104 may provide an interface for third party health information system (HIS) 120 to programmatically access and/or maintain EHRs. Additionally or alternatively, application server(s) 104 may provide a user interface for accessing and/or maintaining EHRs, to a user terminal 110 via network 100, for example.

In some embodiments, EHRs may be stored on EHR database 106, which may be implemented as any number of databases and may be accessible to application server(s) 104 via direct connection and/or over a network. In some embodiments, EHR database 106 may be implemented on the same apparatus as an application server 104.

In some embodiments, system 101 may include EHR versioning apparatus 102 that may be configured to provide versioning capabilities, such as tagging data elements with provenance and/or timestamp information, to one or more application servers 104. EHR versioning apparatus 102 may be directly coupled to the application server(s) 104, or accessed over a network. For example, in embodiments in which an EHR versioning apparatus 102 is disposed remotely from the application server(s) 104, versioning functionality may be provided to the application server(s) 104 via a network 100, by a variety of connections. Network 100 may be embodied in a local area network, the Internet, any other form of a network, or in any combination thereof, including proprietary private and semi-private networks and public networks. The network 100 may comprise a wireline network, wireless network (e.g., a cellular network, wireless local area network, wireless wide area network, some combination thereof, or the like), or a combination thereof, and in some example embodiments comprises at least a portion of the Internet.

In some embodiments, EHR versioning apparatus 102 may manage communication between application server(s) 104 and EHR database 106, acting as a go-between for data access and maintenance, while also providing versioning capabilities. In some embodiments, EHR versioning apparatus 102 may provide versioning services to application server(s) 104 and/or EHR database 106 independently from data request processing operations.

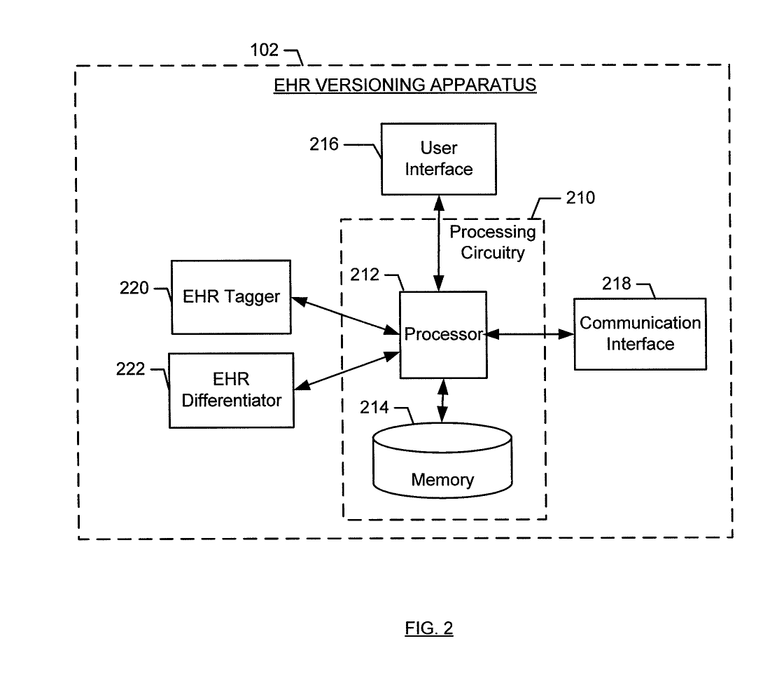

In some example embodiments, EHR versioning apparatus 102 may be embodied as or comprise one or more computing devices, such as, by way of non-limiting example, a server, configured to access application server(s) 104 and/or EHR database 106. In some example embodiments, EHR versioning apparatus 102 may be implemented as a distributed system or a cloud based entity that may be implemented within network 100. In this regard, EHR versioning apparatus 102 may comprise one or more servers, a server cluster, one or more network nodes, a cloud computing infrastructure, some combination thereof, or the like. In some embodiments, EHR versioning apparatus 102 may be implemented in the same apparatus as one or more application servers (104). An example embodiment of EHR versioning apparatus 102 is illustrated in FIG. 2 and is described in further detail hereinafter.

The user terminal(s) 110 may each be embodied as a laptop computer, tablet computer, mobile phone, desktop computer, workstation, or other like computing device. A user terminal 110 may be remote from the application server(s) 104, EHR versioning apparatus 102, and/or EHR database 106, in which case the user terminal 110 may communicate with any of the respective apparatuses via network 100. Additionally or alternatively, the user terminal 110 may be implemented on application server(s) 104, EHR versioning apparatus 102, and/or EHR database 106. A user of user terminal(s) 110, such as a medical practitioner and/or patient, may access EHRs provided by application server(s) 104 via network 100 to access, capture, and/or maintain EHR data to be stored in EHR database 106.

Third party HIS(s) 120 may be any system configured to access application server(s) 104, EHR database(s) 106 and/or EHR versioning apparatus 102, over network 100, for example. In some embodiments, third party HIS(s) 120 may comprise third party application servers configured to communicate with application server(s) 104 to access centrally stored EHRs on EHR database 106. HIS(s) 120 may be administered by a medical services provider, insurance provider, and/or any other entity with access to EHRs stored on EHR database(s) 106.

FIG. 2 illustrates an EHR versioning apparatus 102 in further detail, in accordance with some example embodiments. However, it should be noted that the components, devices, and elements illustrated in and described with respect to FIG. 2 below may not be mandatory and thus some may be omitted in certain embodiments. Additionally, some embodiments may include further or different components, devices, or elements beyond those illustrated in and described with respect to FIG. 2.

Processing circuitry 210 may be configured to perform actions in accordance with one or more example embodiments disclosed herein. In this regard, the processing circuitry 210 may be configured to perform and/or control performance of one or more functionalities of the EHR versioning apparatus 102 in accordance with various example embodiments. The processing circuitry 210 may be configured to perform data processing, application execution, and/or other processing and management services according to one or more example embodiments. In some embodiments, the EHR versioning apparatus 102 or a portion(s) or component(s) thereof, such as the processing circuitry 210, may be embodied as or comprise a circuit chip. The circuit chip may constitute means for performing one or more operations for providing the functionalities described herein.

In some example embodiments, the processing circuitry 210 may include a processor 212 and, in some embodiments, such as that illustrated in FIG. 2, may further include memory 214. The processing circuitry 210 may be in communication with or otherwise control a user interface 216, an EHR tagger 220, EHR differentiator 222, and/or a communication interface 218. As such, the processing circuitry 210 may be embodied as a circuit chip (e.g., an integrated circuit chip) configured (e.g., with hardware, software, or a combination of hardware and software) to perform operations described herein.

The processor 212 may be embodied in a number of different ways. For example, the processor 212 may be embodied as various processing means such as one or more of a microprocessor or other processing element, a coprocessor, a controller, or various other computing or processing devices including integrated circuits such as, for example, an ASIC (application specific integrated circuit), an FPGA (field programmable gate array), or the like. Although illustrated as a single processor, it will be appreciated that the processor 212 may comprise a plurality of processors. The plurality of processors may be in operative communication with each other and may be collectively configured to perform one or more functionalities of EHR versioning apparatus 102 as described herein. The plurality of processors may be embodied on a single computing device or distributed across a plurality of computing devices collectively configured to function as the EHR versioning apparatus 102. In some example embodiments, the processor 212 may be configured to execute instructions stored in the memory 214 or otherwise accessible to the processor 212. As such, whether configured by hardware or by a combination of hardware and software, the processor 212 may represent an entity (e.g., physically embodied in circuitry—in the form of processing circuitry 210) capable of performing operations according to embodiments of the present invention while configured accordingly. Thus, for example, when the processor 212 is embodied as an ASIC, FPGA, or the like, the processor 212 may be specifically configured hardware for conducting the operations described herein. Alternatively, as another example, when the processor 212 is embodied as an executor of software instructions, the instructions may specifically configure the processor 212 to perform one or more operations described herein.

In some example embodiments, the memory 214 may include one or more non-transitory memory devices such as, for example, volatile and/or non-volatile memory that may be either fixed or removable. In this regard, the memory 214 may comprise a non-transitory computer-readable storage medium. It will be appreciated that while the memory 214 is illustrated as a single memory, the memory 214 may comprise a plurality of memories. The plurality of memories may be embodied on a single computing device or may be distributed across a plurality of computing devices collectively configured to function as the EHR versioning apparatus 102. The memory 214 may be configured to store information, data, applications, instructions and/or the like for enabling the EHR versioning apparatus 102 to carry out various functions in accordance with one or more example embodiments. For example, the memory 214 may be configured to buffer input data for processing by the processor 212. Additionally or alternatively, the memory 214 may be configured to store instructions for execution by the processor 212. As yet another alternative, the memory 214 may include one or more databases that may store a variety of files, contents, or data sets. Among the contents of the memory 214, applications may be stored for execution by the processor 212 to carry out the functionality associated with each respective application. In some cases, the memory 214 may be in communication with one or more of the processor 212, user interface 216, communication interface 218, EHR tagger 220, or EHR differentiator 222 for passing information among components of EHR versioning apparatus 102.

The user interface 216 may be in communication with the processing circuitry 210 to receive an indication of a user input at the user interface 216 and/or to provide an audible, visual, mechanical, or other output to the user. As such, the user interface 216 may include, for example, a keyboard, a mouse, a joystick, a display, a touch screen display, a microphone, a speaker, and/or other input/output mechanisms. As such, the user interface 216 may, in some example embodiments, provide means for user control of versioning operations and/or the like. In some example embodiments in which the EHR versioning apparatus 102 is embodied as a server, cloud computing system, or the like, aspects of user interface 216 may be limited or the user interface 216 may not be present. In some example embodiments, one or more aspects of the user interface 216 may be implemented on a user terminal 110. Accordingly, regardless of implementation, the user interface 216 may provide input and output means to facilitate versioning operations in accordance with one or more example embodiments.

The communication interface 218 may include one or more interface mechanisms for enabling communication with other devices and/or networks. In some cases, the communication interface 218 may be any means such as a device or circuitry embodied in either hardware, or a combination of hardware and software that is configured to receive and/or transmit data from/to a network and/or any other device or module in communication with the processing circuitry 210. By way of example, the communication interface 218 may be configured to enable EHR versioning apparatus 102 to communicate with application server(s) 104 and/or EHR database 106. Accordingly, the communication interface 218 may, for example, include supporting hardware and/or software for enabling communications via cable, digital subscriber line (DSL), universal serial bus (USB), Ethernet, or other methods.

In some example embodiments, the processor 212 (or the processing circuitry 210) may be embodied as, include, or otherwise control an EHR tagger 220. As such, the EHR tagger 220 may be embodied as various means, such as circuitry, hardware, a computer program product comprising computer readable program instructions stored on a computer readable medium (for example, the memory 214) and executed by a processing device (for example, the processor 212), or some combination thereof. EHR tagger 220 may be capable of communication with one or more of the processor 212, memory 214, user interface 216, and communication interface 218 to access, receive, and/or send data as may be needed to perform one or more of the functionalities of the EHR tagger 220 as described herein.

EHR versioning apparatus 102 may include, in some embodiments, an EHR differentiator 222 configured to perform functionalities as described herein. Processor 212 (or the processing circuitry 210) may be embodied as, include, or otherwise control an EHR differentiator 222. As such, the EHR differentiator 222 may be embodied as various means, such as circuitry, hardware, a computer program product comprising computer readable program instructions stored on a computer readable medium (for example, the memory 214) and executed by a processing device (for example, the processor 212), or some combination thereof. EHR differentiator 222 may be capable of communication with one or more of the processor 212, memory 214, user interface 216, communication interface 218, and EHR tagger 220 to access, receive, and/or send data as may be needed to perform one or more of the functionalities of the EHR differentiator 222 as described herein. Additionally, or alternatively, EHR differentiator 222 may be implemented on EHR tagger 220. In some example embodiments in which the EHR versioning apparatus 102 is embodied as a server cluster, cloud computing system, or the like, EHR tagger 220 and EHR differentiator 222 may be implemented on different apparatuses.

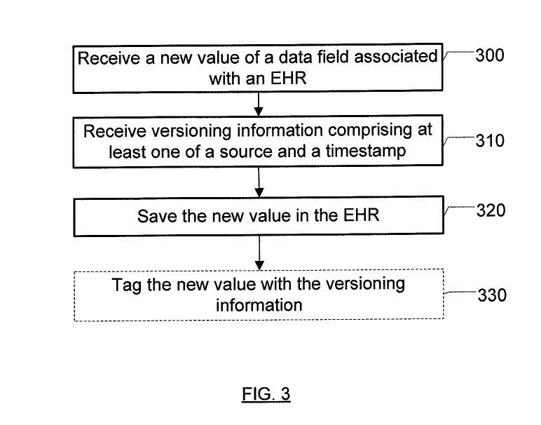

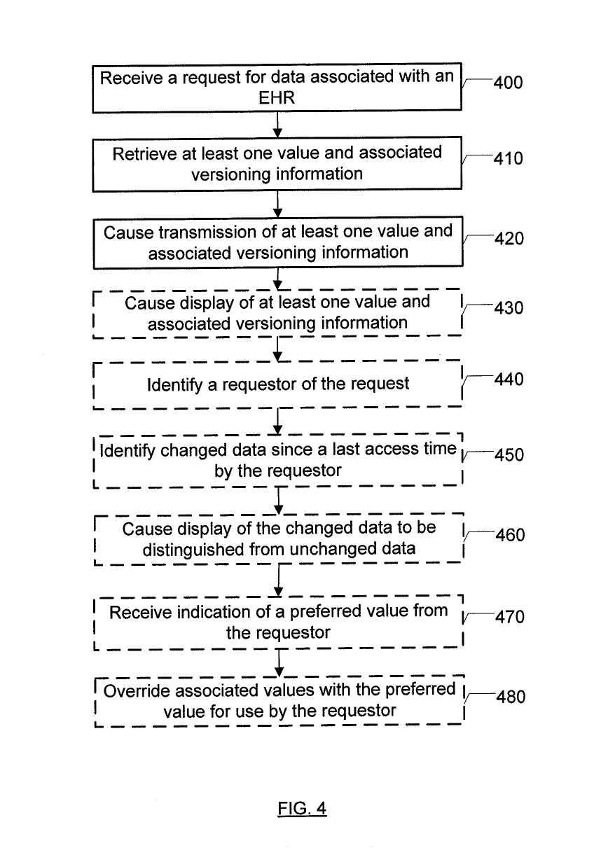

FIGS. 3 and 4 are flowcharts of operations according to some embodiments. Operations illustrated in FIGS. 3 and 4 may be performed by an EHR versioning apparatus and, more particularly, may be performed by, with the assistance of, and/or under the control of one or more of the processing circuitry 210, processor 212, memory 214, user interface 216, communication interface 218, EHR tagger 220, and EHR differentiator 222.

In FIG. 3, at operation 300, EHR tagger 220 may receive, by communication interface 218, for example, a new value of a data element associated with an EHR. At operation 310, EHR tagger 220 may receive versioning information comprising the data source and/or a timestamp. The data source and/or timestamp may be provided via communication interface 218 and/or generated, such as by EHR tagger 220. A source may comprise any information regarding the origin of the new value, such as, for example, a health care provider associated with HIS 120, individual user of HIS 120, role of user of HIS 120, and/or department of user of HIS 120. A timestamp may comprise any information indicating a date and/or time the new value was received or generated by, HIS 120 and/or HIS 102, for example. The versioning information may alternatively or additionally include any other information relating to the version of the value for a data element, such as user-provided tags and/or categories. Providing for customizable versioning information may allow EHR differentiator 222 to provide a more useful view of the data, such as described with respect to the operations of FIG. 4.

At operation 320, HIS 101 may save the new value of the data element in the EHR, in EHR database 106, for example. In some embodiments, EHR versioning apparatus 102 may perform an operation to write a value to an EHR database 106. In some embodiments, EHR versioning apparatus 102 may rely on application server(s) 104 to perform a write and/or save operation and await a response. Regardless of implementation, EHR versioning apparatus 102 may, at operation 330, tag the new value with the versioning information. Tagging the value may include saving the versioning information in one or more fields associated with the data element and specifically the new value.

According to some embodiments, the operations of FIG. 3 may occur as a result of detecting an automated data reconciliation event. In this regard, a component of HIS 101, such as, for example EHR versioning apparatus 102 and/or EHR database 106, may detect or otherwise receive indication of an automated data reconciliation event. Such an event may be triggered by process intended to reconcile, normalize, and/or aggregate data in database EHR 106. For example, a routine batch process may trigger a reconciliation of conflicting spelling of patient names within a single EHR. A change to any data element in the EHR may be tagged by EHR tagger. A data source in this scenario may comprise a name of a routine or process that caused the new value to be saved to EHR database 106.

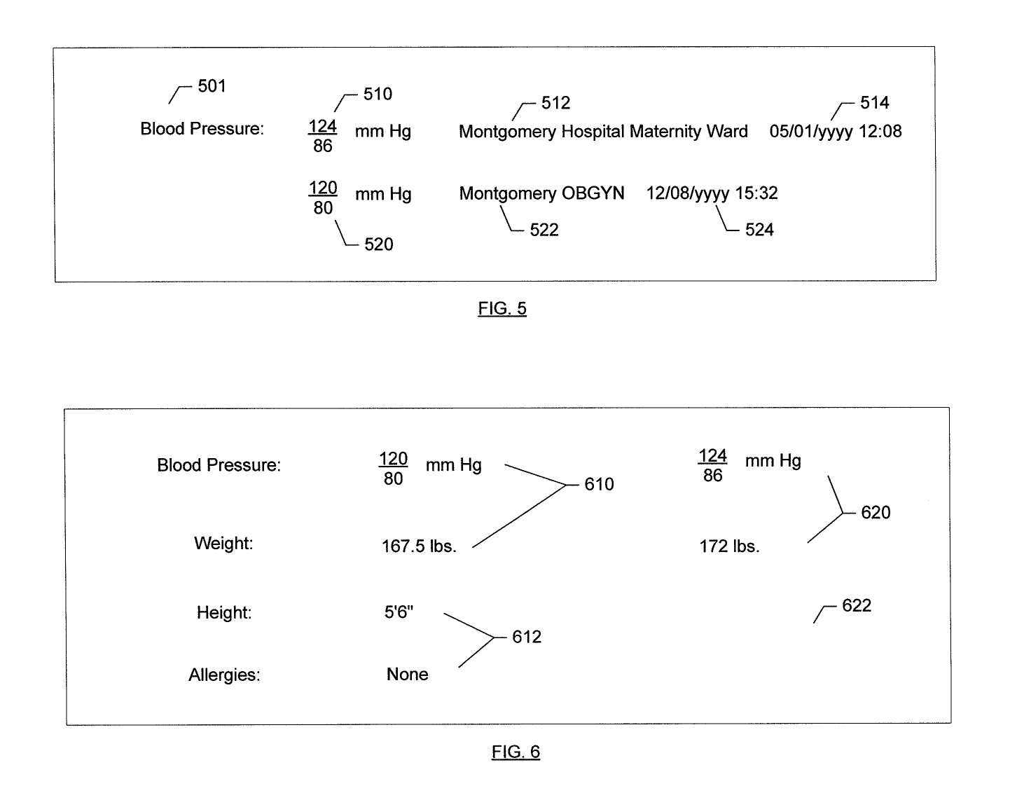

Continuing to FIG. 4, EHR differentiator 222 may receive a request for data associated with an EHR. A request may be received from user terminal(s) 110 and/or third party HIS(s) 120 via network 100 and communication interface 218. At operation 410, EHR differentiator 222 may retrieve at least one value and versioning information associated with the requested data. At operation 420, EHR versioning apparatus 102 may cause transmission of the value(s) and versioning information to a third party HIS 120 via communication interface 218 and network 100, for example. Additionally or alternatively, at operation 430, EHR versioning apparatus 102 may cause display of the values and versioning information on user terminal(s) 100, for example. An example display in accordance with operation 430 is illustrated in FIG. 5.

In FIG. 5, area 501 indicates a name of the data element being displayed. Area 510 displays a value for the data element and associated versioning information in areas 512 and 514. More specifically, area 512 indicates the data source of value 510 while 514 indicates a timestamp associated with value 510. Another value associated with data element 501 is displayed in area 520, with associated data source 522 and timestamp 524. As such, the versioned blood pressure data displayed in FIG. 5 may be beneficial to a user of HIS 102 or 120, for example, because a user can see past history of blood pressure readings. The areas of FIG. 5 may be displayed in a variety of formats. In some embodiments, a user may indicate to view versioning information or past history on an additional display, for example, to conserve space on a main display.

Returning to FIG. 4, operation 440 may provide for identifying a requestor of the request. In this regard, a requestor may be the third party HIS 120 or individual user of an HIS 102, 120, and/or user terminal(s) 110. An identifier may be communicated to HIS 102 via communication interface 218, for example, and may comprise any information used to identify the requestor, such as an electronic certificate identifying a third party, or logon credentials identifying a user. At operation 440, EHR differentiator 222 may identify changed data since a last access time by the requestor. A last access time may include the last time data was viewed, updated to third party HIS(s) 120, or maintained by the requestor. At operation 460, EHR database 106 may cause display of the changed data to be distinguished from unchanged data.

FIG. 6 illustrates an example display with a differentiated view. Area 620 shows changed values when compared to the values of area 610, e.g., the blood pressure readings and weight have changed since the last time the data was accessed by the identified user, or requestor. The absence of data in area 622 indicates the height and allergies in area 612 have not changed since the last access time. The display of FIG. 6 is intended as an example. Displays indicating differential data may distinguish changed data values by using different colors, sizes, borders, and/or any other feature capable of distinguishing changes in data since a last access time. In some embodiments, a display may be provided that only displays changed data values. Additional versioning information may be provided on the same display or upon indication from a user to view the versioning information.

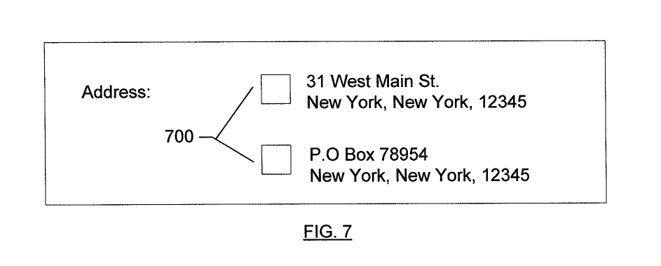

Operation 470 of FIG. 4 provides for receiving indication of a preferred value from a user. FIG. 7 is an example display illustrating two different values for a patient's address. In some embodiments, a user may select to view versioning information associated with the values and/or a user may indicate, such as by indicators 700 of FIG. 7 which value to use for a session and/or subsequent sessions by a user and/or a user associated with the requesting entity, such as the requestor identified in operation 440. At operation 480, EHR tagger 220 and/or EHR differentiator 222 may override associated values with the preferred value for use by the requestor. Using FIG. 7 as an example, a user may want to override an address change that has not yet been provided to a billing health care provider so that the correct address is used throughout third party HIS 120. EHR tagger 220 and/or EHR differentiator 222 may tag a corresponding value in EHR database 106 so that the intended value can be provided to an HIS(s) 120 in the future.

While FIG. 6 illustrates an example display with a differentiated view, and the operations of FIG. 4 describe a method for providing such a display, in some embodiments, EHR versioning apparatus 102 may provide variations of differentiated views, including, but not limited to, customizable differentiated views. In this regard, EHR differentiator 222 may identify data that has been modified or provided by a specific user type. For example, a user may see data provided by a user outside their organization, such as a user from another practice or from another department, display differently from data provided by a same or similar user type. In some embodiments, EHR differentiator 222 may be configured to exclude data provided by a specific user type. For example, a user may opt to view only physician-provided data, to exclude patient self-reported data, and/or to view data provided by members of a core care team, for example. Variations of the differentiated views may be provided by default, or configured by a user to provide a customizable view.

FIGS. 3 and 4 each illustrate a flowchart of a system, method, and computer program product according to some example embodiments. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may comprise one or more memory devices of a computing device (for example, the memory 214) storing instructions executable by a processor in the computing device (for example, by the processor 212). In some example embodiments, the computer program instructions of the computer program product(s) which embody the procedures described above may be stored by memory devices of a plurality of computing devices. As will be appreciated, any such computer program product may be loaded onto a computer or other programmable apparatus (for example, an EHR versioning apparatus 102 and/or other apparatus) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product may comprise an article of manufacture which implements the function specified in the flowchart block(s). The computer program instructions of one or more computer program products may also be loaded onto a computer or other programmable apparatus (for example, an EHR versioning apparatus 102 and/or other apparatus) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included as shown, for example, by the blocks with dashed borders in FIGS. 3 and 4. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
receiving a new value of a data element associated with an electronic health record;
receiving versioning information comprising at least one of a data source or a timestamp;
saving the new value in the electronic health record; and
tagging, by a processor, the new value with the versioning information.

2. A method according to claim 1, further comprising:
receiving a request for data associated with an electronic health record;
retrieving at least one value and associated versioning information; and
causing transmission of the at least one value and associated versioning information.

3. A method according to claim 2, further comprising:
causing display of the at least one value and associate versioning information.

4. A method according to claim 2, further comprising:
identifying a requestor associated with the request;
identifying changed data since a last access time by the requestor; and
causing display of the changed data to be distinguished from unchanged data.

5. A method according to claim 2, further comprising:
receiving indication of a preferred value for a data element from the requestor; and
overriding values of the data element with the preferred value of the requestor.

6. A method according to claim 1, wherein the receiving a new value comprises detecting an automated data reconciliation event.

7. An apparatus comprising processing circuitry configured to cause the apparatus to at least:
receive a new value of a data element associated with an electronic health record;
receive versioning information comprising at least one of a data source or a timestamp;
save the new value in the electronic health record; and
tag the new value with the versioning information.

8. An apparatus according to claim 7, wherein the processing circuitry is further configured to cause the apparatus to at least:
receive a request for data associated with an electronic health record;
retrieve at least one value and associated versioning information; and
cause transmission of the at least one value and associated versioning information.

9. An apparatus according to claim 8, wherein the processing circuitry is further configured to cause the apparatus to at least cause display of the at least one value and associated versioning information.

10. An apparatus according to claim 8, wherein the processing circuitry is further configured to cause the apparatus to at least:
identify a requestor associated with the request;
identify changed data since a last access time by the requestor; and
cause display of the changed data to be distinguished from unchanged data.

11. An apparatus according to claim 8, wherein the processing circuitry is further configured to cause the apparatus to at least:
receive indication of a preferred value from the requestor; and
override associated values with the preferred value for use by the requestor.

12. An apparatus according to claim 7, wherein the receiving a new value comprises detecting an automated data reconciliation event.

13. A computer program product comprising at least one non-transitory computer-readable medium having computer-readable program instructions stored therein, the computer-readable program instructions comprising instructions, which when performed by an apparatus, are configured to cause the apparatus to at least:
receive a new value of a data element associated with an electronic health record;
receive versioning information comprising at least one of a data source or a timestamp;
save the new value in the electronic health record; and
tag the new value with the versioning information.

14. A computer program product of claim 13, wherein the instructions are further configured to cause the apparatus to at least:
receive a request for data associated with an electronic health record;
retrieve at least one value and associated versioning information; and
cause transmission of the at least one value and associated versioning information.

15. A computer program product of claim 14, wherein the instructions are further configured to cause the apparatus to at least cause display of the at least one value and associated versioning information.

16. A computer program product of claim 14, wherein the instructions are further configured to cause the apparatus to at least:
identify a requestor associated with the request;
identify changed data since a last access time by the requestor; and
cause display of the changed data to be distinguished from unchanged data.

17. A computer program product of claim 14, wherein the instructions are further configured to cause the apparatus to at least:
receive indication of a preferred value from the requestor; and
override associated values with the preferred value for use by the requestor.

18. A computer program product of claim 13, wherein receiving a new value comprises detecting an automated data reconciliation event.
